(19) United States
(12) Patent Application Publication
(10) Pub. No.: US 2009/0257323 A1
(43) Pub. Date: Oct. 15, 2009

(54) Watch with rotatable case

(76) Inventor: Ali Soltani, Beverly Hills, CA (US)

Correspondence Address: SEYFARTH SHAW LLP, 131 S. DEARBORN ST., SUITE 2400, CHICAGO, IL, 60603-5803, US

(21) Appl. No.: 12/082,140

(22) Filed: Apr. 9, 2008

(51) Int. Cl. G04B 37/18; G04B 37/00

(52) U.S. Cl. 368/281; 368/309

(57) ABSTRACT

A rotatable wrist watch is provided. The rotatable wrist watch includes a watch case, a dial, a crown, an outer periphery, a wrist strap and a spindle. The watch case has an exterior and an interior. The exterior includes two opposing faces and a side portion. A dial is located on each opposing face with a plurality of dials located on at least one of the opposing faces. Each dial indicates a time. A crown is provided for each dial. Each crown is located on the side portion and is movable to adjust the time indicated by the respective dial. The outer periphery is located a distance from and circumscribing the watch case. The wrist strap is coupled to the outer periphery. The spindle extends between the watch case and the outer periphery and is configured to permit the watch case to pivot about an axis between a first position where one of the watch faces is visible and a second position where the other watch face is visible.

### FIELD OF THE INVENTION

This invention relates generally to watches, and in more particular applications to rotating and/or reversible watches.

### BACKGROUND

Wrist watches are known and used by individuals for indicating time, including hours, minutes, seconds and the date. Additionally, it is often desired to indicate times in a variety of locations for business and personal reasons. For example, when working with a client located far away, it is often desired to know the local time at the client for conference calls and meetings. Additionally, when a person travels frequently, it may be desired to have the times indicated for the various time zones without having to constantly change the indicated time.

In this manner, it is known to include a watch face that can quickly adjust between different time zones. Often, these times zones are indicated on the same dial and the user simply toggles through various time zones, such as with a digital watch.

Rotatable wrist watches are also known whereby the wearer can change the look of the watch by pivoting and/or rotating the face of the watch. In this manner, the wrist watch can have two different styles or designs of faces. For example, the wrist watch can have a casual watch face and a dressy watch face. However, these watches often include complex pivot and rotation mechanisms requiring the removal and/or partial disassembly of some portion of the watch. Alternatively, the watch requires the watch face to pivot out before it can be rotated to expose the second face. These watches have extra parts and/or complex mechanisms that can be misplaced and broken easily.

### SUMMARY

In one form, a rotatable wrist watch is provided. The rotatable wrist watch includes a watch case, a dial, a crown, an outer periphery, a wrist strap and a spindle. The watch case has an exterior and an interior. The exterior includes two opposing faces and a side portion. A dial is located on each opposing face with a plurality of dials located on at least one of the opposing faces. Each dial indicates a time. A crown is provided for each dial. Each crown is located on the side portion and is movable to adjust the time indicated by the respective dial. The outer periphery is located a distance from and circumscribing the watch case. The wrist strap is coupled to the outer periphery. The spindle extends between the watch case and the outer periphery and is configured to permit the watch case to pivot about an axis between a first position where one of the watch faces is visible and a second position where the other watch face is visible.

According to one form, a rotatable wrist watch is provided. The rotatable wrist watch includes a watch case, a dial, a crown, an outer periphery, a wrist strap, a spindle, a protrusion, a groove and a recess. The watch case has an exterior and an interior. The exterior includes two opposing faces and a side portion. A dial is located on each opposing face. Each dial indicates a time. A crown is provided for each dial. Each crown is located on the side portion and is movable to adjust the time indicated by the respective dial. The outer periphery is located a distance from and circumscribing the watch case. The wrist strap is coupled to the outer periphery. The spindle extends between the watch case and the outer periphery and is configured to permit the watch case to pivot about an axis between a first position where one of the watch faces is visible and a second position where the other watch face is visible. The protrusion extends from one of the outer periphery and the side of the watch case. The groove and the recess are located on the other of the outer periphery and the side of the watch case. The groove and recess cooperate to guide the protrusion along the groove towards the recess to releasably retain the watch case relative to the outer periphery.

In one form, a rotatable wrist watch is provided. The rotatable wrist watch includes a watch case, a dial, a crown, an outer periphery, a wrist strap and a spindle. The watch case has an exterior and an interior. The exterior includes two opposing faces and a side portion. A dial is located on each opposing face. Each dial indicates a time. The outer periphery is located a distance from and circumscribing the watch case. The wrist strap is coupled to the outer periphery. The spindle extends between the watch case and the outer periphery and is configured to permit the watch case to pivot about an axis between a first position where one of the watch faces is visible and a second position where the other watch face is visible.

In accordance with one form, the watch case pivots without moving the watch case from the outer periphery.

In one form, the outer periphery is a rigid and integral component.

According to one form, the watch case pivots about a 12-6 axis.

In accordance with one form, one face includes two dials, each dial configured to indicate a different time zone and wherein the other face include two additional dials, one of the two additional dials indicating hours and the other of the two additional dials indicating minutes.

In one form, the rotatable wrist watch further includes four separate crystals on the exterior of the watch with one crystal adjacent each dial.

According to one form, the rotatable wrist watch further includes four separate movements to permit each dial to indicate time.

In one form, the rotatable wrist watch further includes a mechanical movement to keep time.

In accordance with one form, the rotatable wrist watch further includes a quartz movement to keep time.

According to one form, when the dial of a respective face is visible by a user, the crown for the respective dial is also visible.

Other forms are also contemplated as understood by those skilled in the art.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a perspective view of one form of a rotatable wrist watch in a first position;

FIG. 2 is a perspective view of one form of a rotatable wrist watch being rotated from a first position to a second position;

FIG. 3 is a perspective view of one form of a rotatable wrist watch in a second position;

FIG. 4 is a front view of one form of a rotatable wrist watch;

FIG. 5 is a cross-sectional view taken along line 5-5 of FIG. 4;

FIG. 6 is a front view of one form of a rotatable wrist watch;

FIG. 7 is a cross-sectional view taken along line 7-7 of FIG. 6;

FIG. 8 is cross-sectional view taken along line 8-8 of FIG. 6;

FIG. 9 is cross-sectional view taken along line 9-9 of FIG. 6;

FIG. 10 is a perspective view of one form of a rotatable wrist watch in a first position;

FIG. 11 is a perspective view of one form of a rotatable wrist watch being rotated from a first position to a second position; and

FIG. 12 is a perspective view of one form of a rotatable wrist watch in a second position.

### DETAILED DESCRIPTION

One form of a rotatable wrist watch 20 is illustrated in FIG. 1. The watch 20 includes two opposing faces 22,24 and is rotatable so that a user can view the respective face 22,24. Each of the faces 22,24 may include one or more dials 26 cooperating with one or more hands 27 for indicating a time, time period, hour, minute, seconds or the like. In the form illustrated in FIGS. 1-3, the watch 20 includes two dials 26 per face 22,24. Furthermore, the watch 20 can be rotated such that one of the faces 22,24 can be selectively viewed by a user.

Generally, the watch 20 is defined by a watch case 28 having an interior 30, an exterior 32 and a side portion 34. Each of the faces 22,24 are located on the exterior 32 and/or extend to be at least partially viewable on the exterior 32. The watch 20 further includes an outer periphery 36 located outwardly from the watch case 28. One or more pivots, such as spindles 37 extend between the outer periphery 36 and the watch case 28 to permit the watch case 28 to rotate relative to the outer periphery 36. The watch 20 may also include one or more protrusions 38 which cooperate with one or more grooves 40 and/or recesses 42 to releasably retain the watch case 28 in a desired orientation. The components and operation of the watch 20 will be described in more detail below.

The watch case 28 can be formed in a variety of manners to include a variety of components. For example, in one form, the watch case 28 is generally composed of two main portions 44,46 that can be affixed to one another. Specifically, internal components of the watch 20 have to be inserted into the watch case 28. The interior 30 can be sized and shaped to accommodate a variety of internal components, as will be discussed in more detail infra. In this manner, the two main portions 44,46 can be separated and the internal components inserted. The two main portions 44,46 can be affixed to one another in any conventional manner understood by those skilled in the art. For example, the two main portions 44,46 can be affixed using screws 48. In one form, referring to FIG. 3, four screws 48 can be utilized. However, it should be understood that other methods and structures can be used to affix the portions 44,46.

Similarly, it should be understood that the watch case 28 can be composed of more than two portions. For example, the watch case 28 can be composed of three portions. Moreover, the portions can be any size, shape or proportion of the overall watch case 28. In one form, the watch case 28 is circular and the portions 44,46 are approximately half of the overall watch case 28. Furthermore, the watch case 28 may include additional structure understood by those skilled in the art. For example, the watch case 28 includes one or more gaskets 50, such as seen in FIG. 5. The gaskets 50 can be located in various areas and joining locations to improve the water resistance of the watch 20.

The exterior 32 may include various structures to aid in the rotation of the watch case 28. Referring to FIG. 5, the exterior 32 can include one or more pivot recesses 52 to cooperate with the spindles 37. The pivot recesses 52 can further include bushings 54 to decrease friction in the pivot recess 52. The pivot recesses 52 can be sized to accommodate the bushings 54, if used, as well as the spindles 37. Furthermore, the pivot recesses 52 can be located anywhere as desired to provide the desired rotation of the watch case 28. In one form, the pivot recesses 52 are located along a 12-6 axis 56 (such as defined by the location of the 12 o'clock and 6 o'clock positions on the dial). However, it should be understood that the pivot recesses 52 can be located in other locations and orientations to cause the watch case 28 to rotate in a different orientation and manner.

The outer periphery 36 may be formed in a variety of manners and similarly include a variety of structures to aid in the rotation and retention of the watch case 28 relative to the outer periphery 36. In one form, the outer periphery 36 is a single, rigid, integral structure. In this manner, the spindle 37 can be inserted through an opening (not shown) in the outer periphery. In another form, as illustrated in FIG. 8, the outer periphery 36 is composed of an upper portion 58 and a lower portion 60 wherein the upper and lower portions 58,60 are affixed to one another via one or more screws 62. In this form, the spindle can be located between the upper and lower portions 58,60, if desired.

The outer periphery 36 may also include the protrusions 38 located along an inside surface 64 of the outer periphery 36. The protrusions 38 can be located to correspond with the location of the grooves 40 and recesses 42. The protrusions 38 can have a generally rounded portion 66 and a stop portion 68.

The protrusions 38 can also include one or more biasing structures, such as a spring 70. In this manner, the springs 70 will bias the protrusions 38 from the inside surface 64 of the outer periphery 36 towards the watch case 28. Resultantly, the protrusions 38, or more specifically, the rounded portion 66, can contact the grooves 40 whereby the protrusions 38 will be forced away from the watch case 28 as they are guided along the watch case 28. The protrusions 38 will contact the recesses 42 whereby the protrusions 38 will be biased into the recesses 42 to resistively retain the watch case 28 in a desired orientation. When the protrusions 38 are not contacting the watch case 28, the stop portion 68 will prevent the spring 70 from forcing the protrusions 38 completely out of the outer periphery 36. The watch 20 can include any number of protrusions 38 as desired. In one form, the watch 20 includes four protrusions 38 and corresponding grooves 40 and recesses 42.

It should be noted that the outer periphery 36 is located a distance from and circumscribes the watch case 28. This distance and location permits the watch case 28 to rotate while within the outer periphery 36. Furthermore, the outer periphery 36 can help prevent the watch case 28 and the internal components from being damaged.

As discussed above, the spindle 37 assists in the rotation of the watch case 28 relative to the outer periphery 36. The spindle(s) 37 function as rotation points such that the watch case is permitted to rotate about an axis. The spindle 37 may take a variety of forms, such as a rod, bolt screw or the like as understood by those skilled in the art. In one form, the spindle 37 includes a narrowed portion 72 which may be inserted into the pivot recess 52 and/or the bushing 54. In one form, the spindle 37 is threaded into the outer periphery 36 and extends into the watch case 28. However, it should be understood that the spindle 37 may take other forms and may be maintained in the outer periphery in conventional manners as understood by those skilled in the art. Additionally, the spindle 37 and/or recess 52 may include bushings (not shown) or similar structures to assist in rotating the watch case 28.

The watch 20 may include a variety of internal components that may be used to keep and display time, as well as perform other functions. The watch 20 includes one or more forms of movements 80 to keep and display time. In one form, the movement is a mechanical movement 82 (shown schematically in FIG. 7), such that the hands 27 are moved through mechanical operation of gears propelled by a spring or other non-electrical source. In this form, the mechanical movement 82 is an automatic movement. In another form, the movement is a quartz or digital movement 84. In this form, the movement 84 is electrical and powered by a battery or other electric power source.

The watch 20 can have any number and type/combination of movements 80 as desired. For example, in one form, the watch 20 includes four separate movements 80 wherein each movement is quartz. In another form, the watch 20 includes one movement 80 that is quartz. In yet another form, the watch 20 includes four movements 80 that are mechanical. In another form, the watch 20 includes at least one quartz movement and one mechanical movement. It should be understood by those skilled in the art that any type, number and/or combination of movements may be utilized. Furthermore, the movements 80 may include additional functions and features. For example, the watch 20 may include a date function and/or a chronograph function. Moreover, the watch 20 can be designed such that the face which is not displayed when worn, will not be powered to display the time. The face will still operate keep correct time, but the face is not powered to conserve energy.

The movements 80 control the hands 27 which cooperate with the dials 26 to indicate time. The watch 20 can include any number ant type of dials 26 as understood by those skilled in the art. For example, various forms of dials 26 are illustrated in FIGS. 1 and 3. In this form, the watch 20 includes four different dials 26. As shown in FIG. 1, the dials 26 and hands 27 are two different combinations that can be set to indicate two different times, such as for two different time zones. As shown in FIG. 3, the dials 26 and hands 27 include one dial 26 and hand 27 combination that indicates the hour while the other dial 26 and hand 27 combination indicates the minutes.

The dials 26 and hands 27 can be viewed through one or more crystals 86. The crystals 86 can be any conventional crystal as understood by those skilled in the art. The watch 20 may include one crystal 86 per face 22,24. Alternatively, the watch 20 may include multiple crystals 86, such as two crystals 86 per face as shown in FIGS. 1 and 3.

The watch 20 may also include structures to adjust the time and operate other time keeping features of the watch. For example, the watch 20 includes one or more crowns 90. The crowns 90 include stems (not shown) which extend from the crowns 90 and can be used to manipulate the movements 80. Similarly, the watch 20 can include buttons (not shown) or other structure to manipulate the movements 80. Additionally, the watch 20 can include a combination of crowns 90 and buttons. The crowns 90 and/or buttons can be used to set or adjust the indicated time and date as well as start stop and adjust other watch features, such as a chronograph feature. Additionally, the crowns 90 can be used to wind the watch 20 in the case of mechanical movements.

The watch 20 can include any number of crowns 90 and/or buttons. For example, referring to FIGS. 1-3, the watch 20 include four crowns 90, one for each movement. Alternatively, the watch 20 can include multiple crowns 90 and/or buttons per movement 80. In yet another form, the watch 20 includes a single crown 90 and/or button for all movements 80.

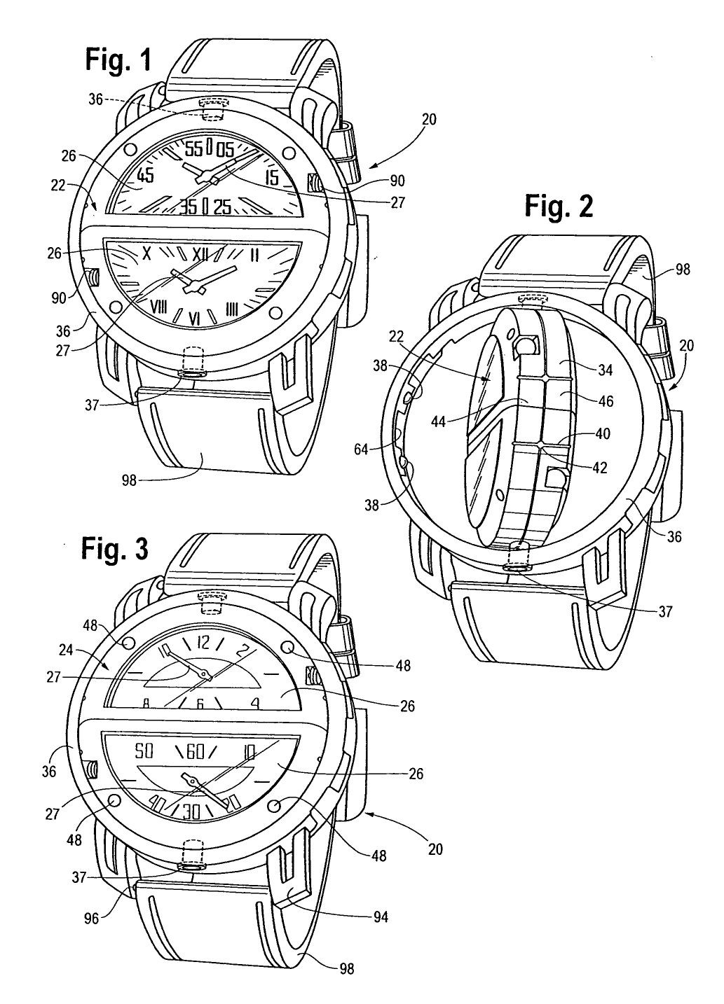

The crowns 90 and/or buttons can be located in various places on the watch 20. Referring to FIGS. 1-3, in one form, the watch 20 includes crowns 90 located on the side portion 34. In this form, the crowns 90 are somewhat protected from damage and accidental movement by the outer periphery 36. The crowns 90 do not extend beyond the outermost portion of the watch case 28 when the watch 20 is in the first or the second position, as shown in FIGS. 1 and 3. In this form, the crowns 90 may be located such that they are always adjustable and/or that the crowns 90 can only be adjusted when the watch case 28 is being rotated, as shown in FIG. 2. The crowns 90 may then be pulled outwardly to rotate and adjust the indicated time. In yet another form, the crowns 90 can be located in other locations, such as at the 6 o'clock and 12 o'clock positions as shown in FIGS. 10 and 12. In this form, the crowns 90 can be located adjacent the spindle 37 and are located about the pivot axis.

The watch 20 may also include even further features as understood by those skilled in the art. For example, the watch 20 may include lugs 94, pin 96 and strap 98. These structures are generally understood by those skilled in the art of wrist watches. Specifically, these structures can be used to retain the watch 20 on a user's body, such as on the wrist. It should be understood that strap 98 may take a variety of forms, including, but not limited to, a strap and/or bracelet.

The watch 20 may be manufactured from a variety of materials as understood by those skilled in the art. For example, the watch 20 may be manufactured from metal, such as stainless steel, gold, platinum, titanium, silver and the like. Additionally, the watch 20 may be manufactured from other materials such as plastic, leather and other materials understood by those skilled in the art.

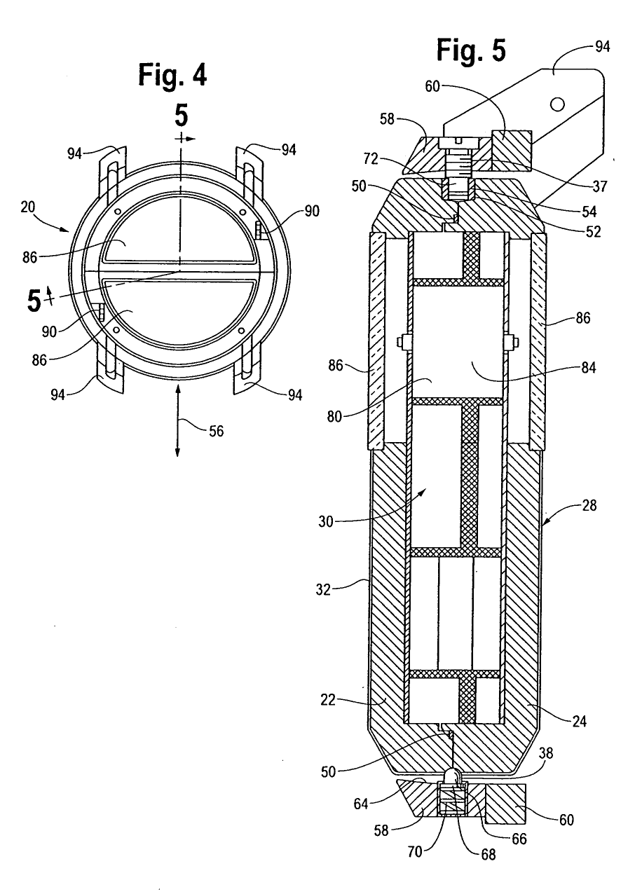

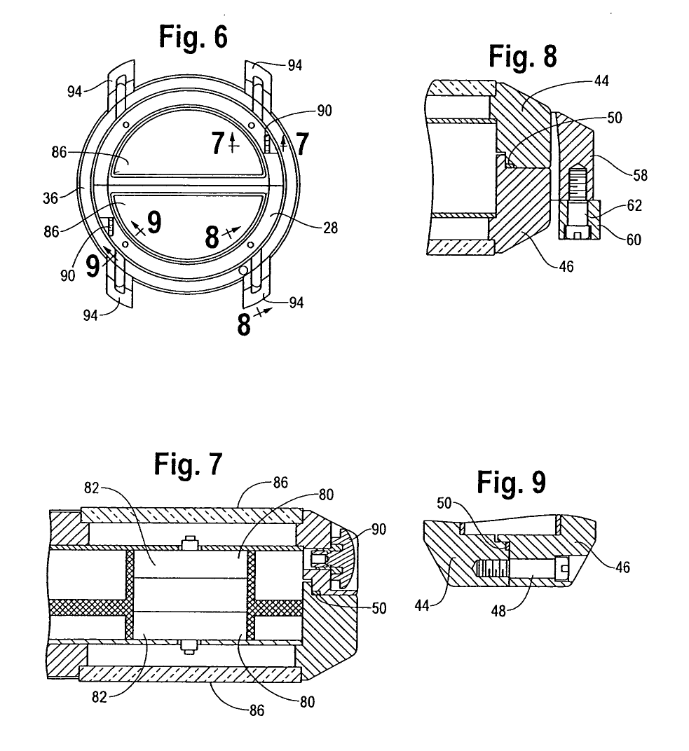

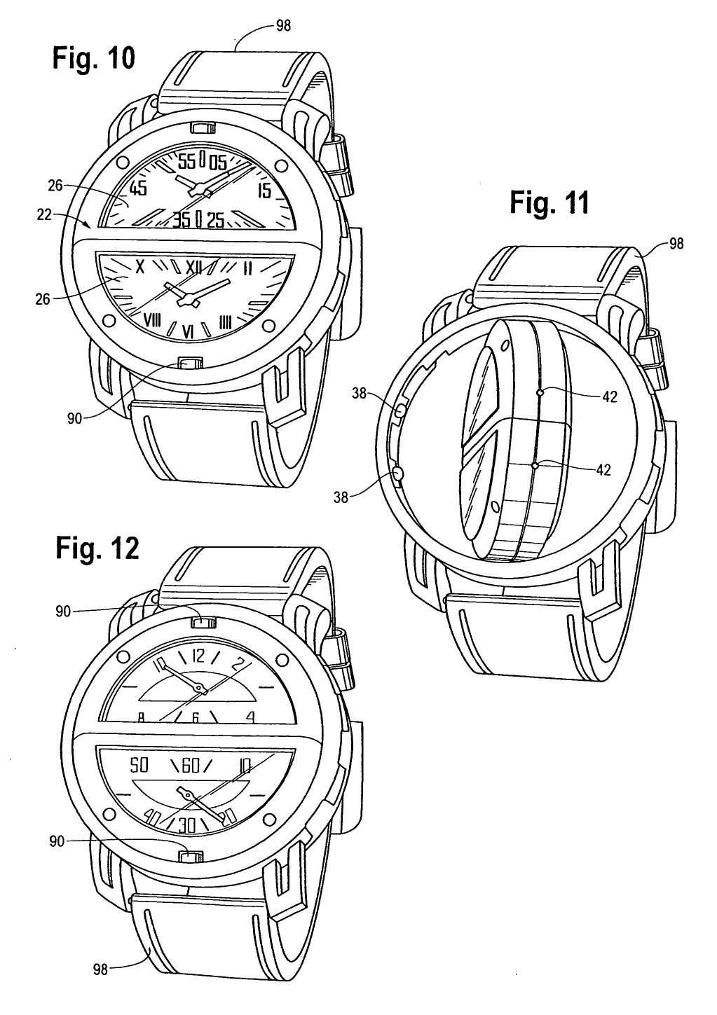

The watch 20 will generally function to keep time as understood by those skilled in the art. The watch 20 is reversible such that the watch case 28 rotates to expose a desired face 22,24 when worn by a user. The watch case 28 is rotatable about the spindle 37 and corresponding pivot recess 52 which cooperate to provide the pivot axis. In one form, the watch case 28 is rotatable either clockwise or counterclockwise about the axis. In another form, the watch case 28 can only rotate in a single direction. The watch case 28 is rotatable when the user loosens and/or removes the watch 20 from his or her body. In a preferred form, the watch case 20 rotates about the 12-6 axis, as represented by arrow 56 in FIG. 4. It should be understood that the watch case 28 can rotate about any axis as desired.

It should be noted that the watch case 28 is free to rotate without having to removed the watch case 28 from the outer periphery 36 and/or remove any portion of the outer periphery 36. This is because there is a distance between the watch case 28 and the outer periphery to permit such rotation.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

1. A rotatable wrist watch comprising:
a watch case having an exterior and an interior, the exterior including two opposing faces and a side portion;
a dial located on each opposing face with a plurality of dials located on at least one of the opposing faces, each dial indicating a time;
a crown for each dial, each crown located on the side portion and movable to adjust the time indicated by the respective dial;
an outer periphery located a distance from and circumscribing the watch case;
a wrist strap coupled to the outer periphery; and
a spindle extending between the watch case and the outer periphery and configured to permit the watch case to pivot about an axis between a first position where one watch face is visible and a second position where the other watch face is visible.

2. The rotatable wrist watch of claim 1 wherein the watch case pivots without moving the watch case from the outer periphery.

3. The rotatable wrist watch of claim 1 wherein the outer periphery is a rigid and integral component.

4. The rotatable wrist watch of claim 1 wherein the watch case pivots about a 12-6 axis.

5. The rotatable wrist watch of claim 1 wherein one face includes two dials, each dial configured to indicate a different time zone and wherein the other face include two additional dials, one of the two additional dials indicating hours and the other of the two additional dials indicating minutes.

6. The rotatable wrist watch of claim 5 further comprising four separate crystals on the exterior of the watch with one crystal adjacent each dial.

7. The rotatable wrist watch of claim 5 further comprising four separate movements to permit each dial to indicate time.

8. The rotatable wrist watch of claim 1 further comprising a mechanical movement to keep time.

9. The rotatable wrist watch of claim 1 further comprising a quartz movement to keep time.

10. The rotatable wrist watch of claim 1 wherein when the dial of a respective face is visible by a user, the crown for the respective dial is also visible.

11. A rotatable wrist watch comprising:
a watch case having an exterior and an interior, the exterior including two opposing faces and a side portion;
a dial located on each opposing face, each dial indicating a time;
a crown for each dial, each crown located on the side portion and movable to adjust the time indicated by the respective dial;
an outer periphery located a distance from and circumscribing the watch case;
a wrist strap coupled to the outer periphery;
a spindle extending between the watch case and the outer periphery and configured to permit the watch case to pivot about an axis between a first position where one watch face is visible and a second position where the other watch face is visible;
a protrusion extending from one of the outer periphery and the side of the watch case; and
a groove and a recess located on the other of the outer periphery and the side of the watch case, the groove and recess cooperating to guide the protrusion along the groove towards the recess to releasably retain the watch case relative to the outer periphery.

12. The rotatable wrist watch of claim 11 wherein the watch case pivots without moving the watch case from the outer periphery.

13. The rotatable wrist watch of claim 11 wherein the outer periphery is a rigid and integral component.

14. The rotatable wrist watch of claim 11 wherein the watch case pivots about a 12-6 axis.

15. The rotatable wrist watch of claim 11 wherein one face includes two dials, each dial configured to indicate a different time zone and wherein the other face include two additional dials, one of the two additional dials indicating hours and the other of the two additional dials indicating minutes.

16. The rotatable wrist watch of claim 15 further comprising four separate crystals on the exterior of the watch with one crystal adjacent each dial.

17. The rotatable wrist watch of claim 15 further comprising four separate movements to permit each dial to indicate time.

18. The rotatable wrist watch of claim 11 further comprising a mechanical movement to keep time.

19. The rotatable wrist watch of claim 11 further comprising a quartz movement to keep time.

20. The rotatable wrist watch of claim 11 wherein when the dial of a respective face is visible by a user, the crown for the respective dial is also visible.

21. A rotatable wrist watch comprising:
a watch case having an exterior and an interior, the exterior including two opposing faces and a side portion;
a dial located on each opposing face, each dial indicating a time;
an outer periphery located a distance from and circumscribing the watch case;
a wrist strap coupled to the outer periphery; and
a spindle extending between the watch case and the outer periphery and configured to permit the watch case to pivot about an axis between a first position where one of the watch faces is visible and a second position where the other watch face is visible.
